(19) United States
(12) Patent Application Publication
(10) Pub. No.: US 2005/0111944 A1
(43) Pub. Date: May 26, 2005

(54) Compact wafer handling system with single axis robotic arm and prealigner-cassette elevator

(76) Inventors: Marc Aho, Aptos, CA (US); Daniel Tran, San Jose, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/723,298

(22) Filed: Nov. 25, 2003

(51) Int. Cl. B65G 65/34; B65B 21/02

(52) U.S. Cl. 414/416.01

(57) ABSTRACT

A robotic single axis system includes an effector moveable around a single rotating axis. The system is substantially concentrically arranged and mounted adjacent a wafer chuck of a precision stage. The robotic effector has a tangential distal end with a carrying face for positioning the wafer between concentric pinlifters raising from the wafer chuck. The pinlifters load and unload the wafer from the effector. The effector reaches with addition of the stage's travel into a cassette and alternating into a prealigner positioned on top of each other on an adjacent elevator. The elevator provides Z-axis movement so that the effector may load and unload wafers from the cassette, and alternating inserts a carried wafer into the prealigner.

### CROSS REFERENCE

The present application cross references the concurrently filed and commonly owned U.S. patent application titled “Compact Pinlifter Assembly Integrated in Wafer Chuck” by Daniel Tran, which is hereby incorporated by reference.

### FIELD OF INVENTION

The present invention relates to wafer handling systems. Particularly, the present invention relates to wafer handling systems including a robotic arm, a prealigner, and an X-Y precision positioning stage.

### BACKGROUND OF INVENTION

During wafer fabrication, wafers are repeatedly transferred in cassettes between measurement devices for testing and/or monitoring their fabrication progress and the like. The environment in which wafer fabrication, testing and/or monitoring takes place is subjected to stringent standards making environment real estate very cost intensive. For that and other well known purposes it is desirable to perform the required tasks within a minimal footprint. The present invention addresses this need.

Another aspect of economic wafer fabrication is to provide repetitive basic tasks in a reliable fashion with a minimum of infrastructure. Especially, wafer transfer between a cassette, a prealigner and a measurement location is preferably provided with a minimum of mechanical effort. The present invention addresses also this need.

Wafers are commonly stacked in cassettes in relatively loose fashion and are pre-aligned before positioning on the wafer chuck. For that purpose, a variety of prealigners are commercially available. Commercial prealigners have commonly a footprint that is a fractional proportion larger than the wafer itself. Thus, as wafer sizes increase, commercial prealigners increase as well. This puts even more pressure on developing wafer handling systems that are inexpensive and utilize commercially available prealigners without compromising the demands for minimal overall footprint. The present invention addresses this need.

Wafer transfer between cassette, prealigner and wafer chuck is typically performed by robotic arms. In prior art systems, such robotic arms feature multiple joints to provide a required degree of movement freedom for moving and placing the wafers between cassette, prealigner and measurement location. At the same time, the robotic arms have to move with sufficient precision in a tightly controlled fashion in order to provide positioning accuracy and positioning repeatability. Multiple joint robotic arms are consequently expensive and space consuming. Therefore, there exists a need for a wafer handling system that utilizes a simple and inexpensive robotic arm. The present invention addresses this need.

### SUMMARY OF INVENTION

A compact wafer handling system provides a single axis rotating robotic arm mounted on a precision wafer positioning stage in combination with a double platform elevator. The positioning stage has a movement range that depends on the wafer size such that the entire wafer area is accessible by a fixed measurement head placed above the stage. The stage has also a wafer chuck for fixedly holding the wafer. Pinlifters are recessed in the wafer chuck and may be raised and lowered for lifting and lowering a wafer.

The elevator provides two platforms. The top platform is configured for receiving a wafer cassette whereas the elevator's bottom platform is configured for carrying a commercial prealinger. The robotic arm is configured in conjunction with a movement range and pinlifters of the X-Y stage. The elevator again is configured and positioned in conjunction with the positioning stage's movement range, the robotic arm's range and the wafer's size such that the overall footprint of the handling system is at a minimum for a given wafer size.

In order to facilitate the single axis robotic arm, an effector is shaped incorrespondence with the pinlifters' ositions on the chuck. The effector has a distal tangential portion with a carrying face for centrally contacting the wafer bottom. The pinlifters are positioned and configured for lifting the wafer above the carrying face in a balanced fashion. The pinlifters are preferably concentrically arrayed on the wafer chuck with at least one spacing being sufficient large such that the carrying face may be moved into central position with respect to the chucks center axis without colliding with the raised pinlifters.

The pinlifters are arrayed at a distance to the chuck center that is slightly larger than the carrying face's size. Consequently, the tangential arm portion may be kept to a minimum. The effector's rotation axis is placed closely to the wafer chuck such that the arm may have a minimum length necessary for the carrying face to reach the chuck center. The minimum size of the tangential arm portion and the arm's overall length results in a minimum parking space of the robotic arm. The robotic arm is driven by a controlled motor via a timing belt reduction gear for a smooth and precise angular effector movement. The elevator is placed such that the robotic effector may reach with full travel of the positioning stage sufficiently into the cassette and the prealigner as necessary to load/unload and/or prealign a wafer. The elevator has a Z-axis movement range such that the effector may access each level of the cassette as well as the prealigner placed on the elevator below the cassette.

### DESCRIPTION OF THE FIGURES

FIG. 1 is a perspective view of a wafer testing device with an effector in chuck loading orientation.

FIG. 2 is a front view of the wafer testing device of FIG. 1 with the effector in chuck loading orientation.

FIG. 3 is a front view of the wafer testing device of FIG. 1 with the effector in elevator alignment orientation accessing the cassette.

FIG. 4 is a perspective view from above onto the wafer testing device according to FIG. 3.

FIG. 5 is a front view of the wafer testing device of FIG. 1 with the effector in elevator alignment orientation accessing the prealigner.

FIG. 6 is a perspective view from above onto the wafer testing device according to FIG. 5.

FIG. 7 is a perspective view from above onto the wafer testing device with the measurement head assembly being hidden for the purpose of improved visibility. The effector is in chuck loading position with pin lifters in their top position.

FIG. 8 is a first perspective view from above corresponding to the view direction of FIG. 7 onto a precision stage assembly with attached robotic single axis system. The effector is in chuck loading position with pin lifters in their top position.

FIG. 9 is a second perspective view from above corresponding to the view direction of FIG. 1 onto a precision stage assembly with attached robotic single axis system. The effector is in chuck loading position with pin lifters in their top position.

FIG. 10 is a left view onto a precision stage assembly with attached robotic single axis system. The effector is in chuck loading position with pin lifters in their top position.

FIG. 11 is a perspective view on the robotic single arm assembly.

FIG. 12 is the robotic single arm assembly cut along a plane through the rotation axis of the effector and substantially symmetric with respect to a radial arm of the effector.

### DETAILED DESCRIPTION

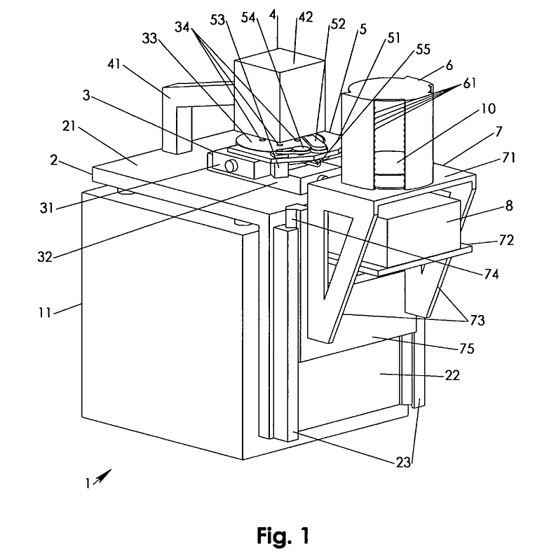

In accordance to FIG. 1, a wafer testing device 1 may be a well known spectrometer, reflectometer or other well known wafer testing device in which a wafer 10 needs to be moved and positioned with high precision. beneath and relative to a measurement head 42. In the Figures, the wafer 10 is a representation of a multitude of wafers that may be handled during operational use of the wafer testing device 1. Hence, where it is referred in the following to wafer 10 any single or multiple equally sized wafer(s) may be considered as appropriate and as it may well be appreciated by anyone skilled in the art.

The wafer testing device 1 may have a housing 11 combined with a base 2. The housing 11 may have any suitable configuration for providing structural support and for integrating additional well known components such as, for example, electrical and other supply devices, control computers and other devices that are well known parts of optical measurement devices.

The base 2 has preferably a horizontal base plate 21 and vertical base plate 22. The horizontal base plate holds a measurement assembly 4 which may include a head carrying arm 41 and a measurement head 42. The scope of the invention is not limited to a particular configuration of the measurement assembly 4. The scope of the present invention includes embodiments, in which a measurement assembly is held within the wafer testing device 1 in any other fashion besides that exemplarily depicted in the Figures.

Attached to and carried by the horizontal base plate 21 is a stage system 3 including for example a high precision linear X-stage 31 and a high precision linear Y-stage 32. X-stage 31 and Y-stage 32 may be combined in a single commercially available device. On top of the stage system 3 is a well known chuck 33 for receiving and fixedly holding the wafer 10 during measurement. The chuck 33 may have concentrically embedded pinlifters 34 for lifting and lowering the wafer 10 with respect to the chuck 33. The stage system 3 provides a movement range and a positioning accuracy such that a predefined area of the wafer 10 may be accessed for measurement and positioned with an accuracy required by the measurement process employed by the wafer testing device 1.

The scope of the invention includes embodiments with a single linear precision stage, which may be the Y-stage 32. In such alternate embodiments, the linear X-stage 31 may be substituted by a precision rotary stage as may be well appreciated by anyone skilled in the art.

The stage system 3 further includes a robotic single axis system 5 for transferring the wafer 10 in combination with an elevator 7 between the chuck 33, a cassette 6 and a prealigner 8. The robotic single axis system S includes an assembly plate 51 attached to the X-stage 31. The assembly plate 51 holds a rotatable effector 52, a motor 53, a reduction gear 54 and a vacuum supply 55.

The vertical base plate 22 features vertical guides 23 that correspond to elevator guides 74 which are attached to and/or part of an elevator frame 75. Fixed to the elevator frame 75 via platform supports 73 are also a cassette platform 71 and a prealigner platform 72. The cassette platform 71 is configured for receiving and positioning the cassette 6 and alternating multiple representations of it in a well known fashion. The cassette 6 has multiple wafer stacking positions 61 as is well known in the art for carrying a number of wafers such as wafer 10. The prealigner platform 72 is configured for carrying and fixedly holding the prealigner 8. The elevator 7 is actuated by well known driving means such as, for example an electromotor and a thread spindle.

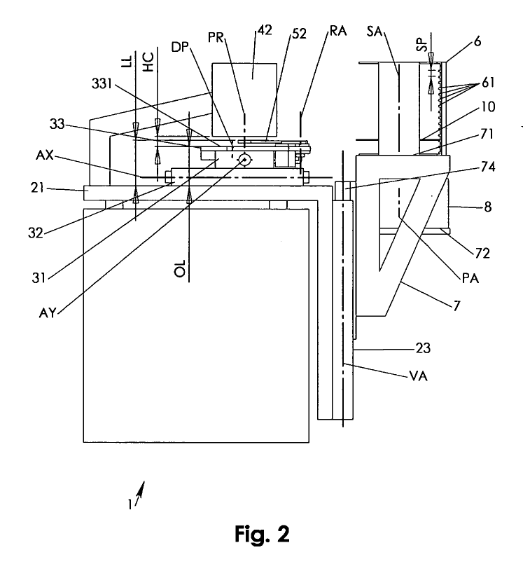

As shown in FIG. 2 and in the exemplary case of employed X-stage 31 and Y-stage 32, the X-stage 31 may have an X-travel along a linear precision axis AX and the Y-stage 32 may have a Y-travel along a linear precision axis AY. Axes AX and AY are preferably perpendicular to each other. The linear precision axis AX may be substituted by a precision rotation axis PR of the chuck 33 in case the X-stage 31 is substituted by a rotating stage. The pinlifters 34 are moveable along a dual positioning axis DP between a top position and a bottom position. The effector 52 is rotatable around a handling rotation axis RA between a chuck loading orientation and at least one elevator alignment orientation. The elevator is actuated along a vertical gross postioning linear axis VA. The prealinger 8 has a prealigner operating axis PA which is fixed with respect to the elevator 7. The cassette 6 is positioned with respect to the elevator 7 such that a wafer stacking axis SA of the cassette 6 is in a predefined position. The cassette platform 71 is preferably configured for receiving and positioning the cassette 6 such that the stacking axis SA is substantially collinear with the prealigner operating axis PA. In that case there is only a single elevator alignment orientation for the effector 52. The wafer 10 is stacked within the cassette 6 such that the wafer center substantially coincides with the stacking axis SA. The wafer stacking levels 61 have a stacking pitch SP. Cassette 6 may be replaced by another equally configured cassette during the operational use of the wafer testing device 1.

The chuck 33 has a wafer holding face 331, which defines an operation level OL at which the wafer 10 is positioned with its bottom surface during operational measurement of the wafer testing device 1. The operational measurement is preferably provided in closest proximity to the wafer top surface defining a certain head clearance HC between the operation level OL and the bottom face of the measurement head 42. The robotic single axis system 5 is configured to provide loading and unloading of a wafer 10 to and from the wafer holding face 331 on a loading level LL within a minimum head clearance HC of about 1.25 inches plus an exemplary wafer thickness of about 0.75 mm for a wafer 10 having a diameter of about 300 mm.

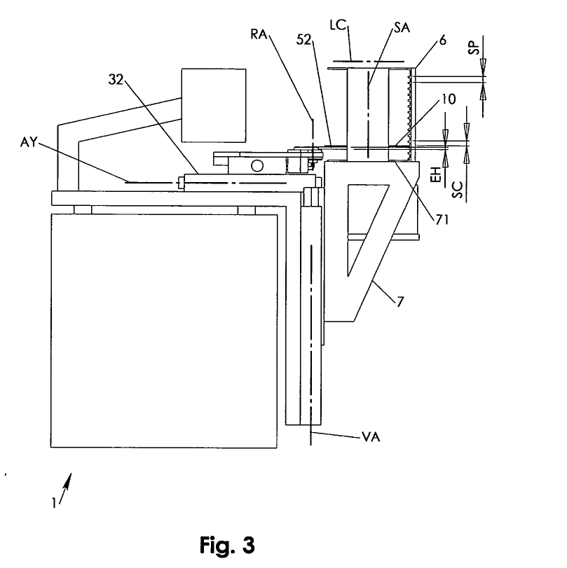

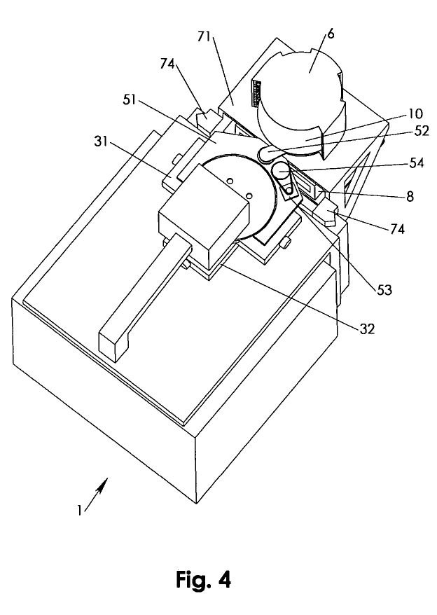

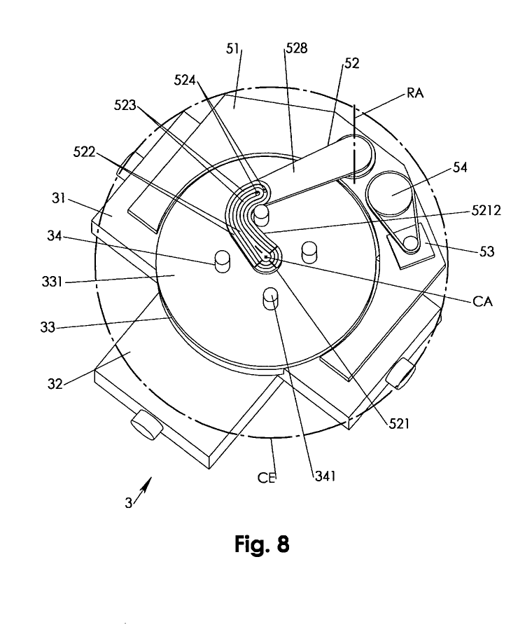

FIGS. 3, 4 show the wafer testing device 1 during loading of wafer 10 from its stack position with the cassette 6 onto the effector 52. Y-stage 32 is actuated and positioned approximately at one end of its Y-travel close to the elevator 7 after the effector 52 is rotated around its handling rotation axis RA into its first elevator alignment orientation. The cassette 6 is positioned on the cassette platform 71 such that a distal carrying face 522 (see FIGS. 8, 9, 12) interferes the stacking axis SA in its first elevator alignment orientation. The height of the wafer 10 reduces the stacking pitch SP to a stacking clearance SC within which the effector 52 has to fit with its effector height EH. Consequently and in compliance with elevator positioning tolerances the effector height EH is selected to avoid contact with the wafer 10 and/or other stacked wafers during its movement into and/or out of the cassette 6.

The wafer 10 may be unloaded from the cassette 6 by a lowering of the elevator 7 such that the wafer 10 is contacting the carrying face 522 and the wafer's 10 weight is shifted from the corresponding stacking position 61 onto the effector 52. A vacuum applied to the carrying face 522 may assist in holding the wafer 10 onto the effector carrying face 522. The cassette 6 may be loaded/unloaded along loading direction LC, which is preferably linear. In the preferred embodiment, the cassette 6 is positioned on the elevator 7 such that the loading direction LC is substantially parallel to the linear axis AY. The wafer 10 is consequently moved out of the cassette 6 via the actuated Y-stage 32 traveling towards its distal travel end away from the elevator 7. Likewise, loading the wafer 10 into the cassette 6 is performed by reversing the steps described in this paragraph.

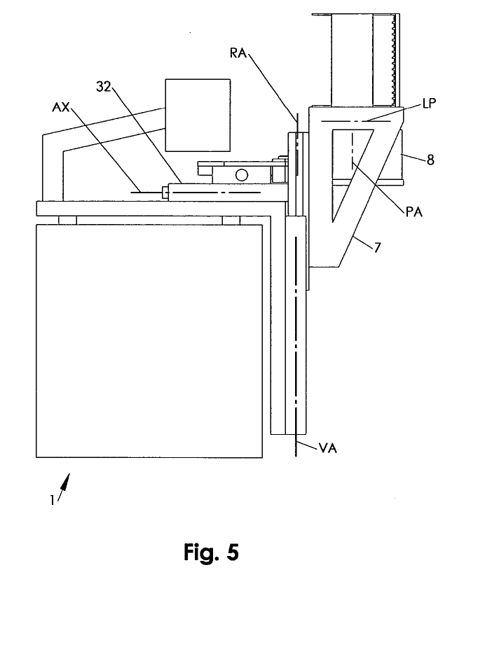

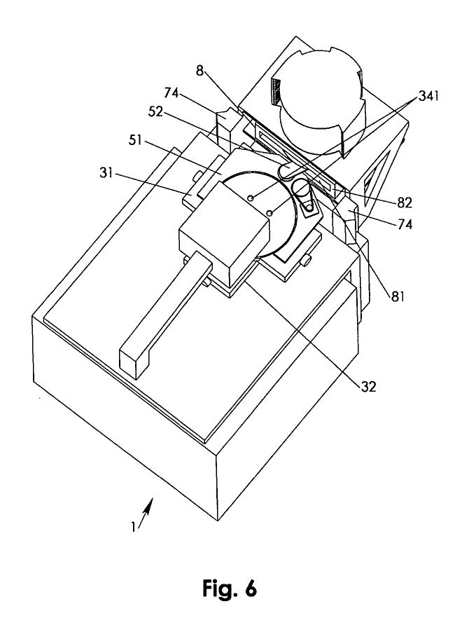

Similar to the teachings of FIGS. 3 and 4, the wafer 10 may be temporarily inserted into the prealigner 8 along the prealinger loading direction LP, as is illustrated in FIGS. 5 and 6. Here, the effector 52 may be brought into a second elevator alignment orientation where the carrying face is brought into interference with the prealigner operating axis PA. There, the prealigner 8 may perform a well known prealignment of the wafer 10. This may be optionally accomplished by an assisting vertical movement of the elevator 7 to induce a relative vertical movment of the wafer 10 with respect to the prealigner 8. In the preferred embodiment, loading directions LC and LP are substantially collinear. The terms loading directions LC and LP are introduced solely for the purpose of explaining the working concept of the present invention without any limiting effect on cassette 6 and prealigner 8. As may be well appreciated by anyone skilled in the art, cassette 6 and prealinger 8 may be alternating loaded/unloaded in any suitable fashion and corresponding with eventual particularities of cassette 6 and prealinger 8.

FIGS. 4 and 6 illustrate the tight spatial conditions that exist during access of cassette 6 and prealigner 8 as a consequence of keeping the Y-travel to a minimum defined by the operational measurement access of the wafer 10. All involved components, such as assembly plate 51, elevator guides 74, platforms 71, 72 as well as positions of cassette 6 and prealigner 8 with its access slot 81 and its front 82 have to be adjusted to each other to avoid collision during the accessing of the cassette 6 and the prealigner 8. In the exemplary embodiment depicted in the Figures, cassette 6 and prealigner 8 are positioned on the elevator 7 such that their respective cassette loading axis LC and prealigner loading axis LP are substantially parallel to the linear axis AY. First and second elevator alignment orientations are thereby substantially the same.

The scope of the invention includes embodiments in which one or both of the loading axes LC, LP are aligned with a virtual loading axis that may be composed of a combined movement of the affiliated components around at least two of axes AY, RA, and AX. In that case, the travel of the wafer 10 along the loading axes LC, LP may be extended beyond the travel of a single affiliated device. For example, a virtual loading axis may be defined that is in a 45 degree to the axes AX and AY. In that example, the loading travel of the wafer 10 along the virtual loading axis may be the square root of the sum of each of X-travel's and Y-travel's square. Elevator 7 may be accordingly configured and positioned together with the cassette 6 and prealigner 8 as may be well appreciated by anyone skilled in the art.

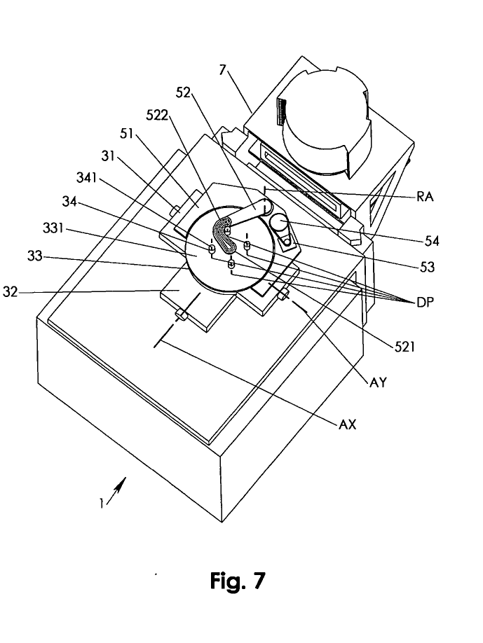

In FIGS. 7 and 8, the effector 52 is again shown in its chuck loading orientation. After the wafer 10 is taken from the cassette 6 and prealigned in the prealigner 8, the wafer 10 may be loaded onto the wafer holding face 331. For that purpose, pin lifters 34 are brought into top position where their top faces 341 are above the loading level LL. During the movement of the pinlifters 34 into their top position, the wafer's 10 bottom is contacted by the top faces 341 and consequently the wafer 10 lifted off the carrying face 522. At that time, any vacuum is released from the interface between carrying face 522 and wafer 10 bottom. Once the wafer 10 is fully supported by the pinlifters 34 and cleared off the carrying face 522, the effector 52 may be rotated into a parking position preferably within the lateral boundaries of the assembly plate 51.

The interaction between pinlifters 34 and effector 52 is warranted on one hand by a collision free movement of the pinlifters 34 between their bottom and top position while the effector 52 is in chuck loading orientation. On the other hand, the effector 52 is shaped to be rotated freely between the pin lifters 34 raised to their top position. For that purpose, the effector 52 features a tangential distal portion 521 laterally protruding at the end of the effector's 52 radial arm portion 528. The distal portion 521 is approximately tangentially oriented with respect to the effector's 52 rotation axis RA. Particularly, the inside contour 5212 of the distal portion 521 is shaped to remain at a minimum distance to the corresponding pin lifter during effector 52 rotation. Consequently, the carrying face 522 may be brought into interference with the chuck's 33 center axis CA for a centered placement of the wafer 10 and the effector 52 may be freely removed while the wafer 10 is resting on the top faces 341. In case of an employed precision rotating stage, the center axis CA is the rotating axis PR.

Once the effector 52 is rotated out off the lateral boundaries of the wafer 10, the pin lifters 34 may be gradually lowered until the wafer 10 comes in contact with the carrying face 331. Loading from the wafer holding face 331 onto the carrying face 521 is performed in reverse order of the steps described for unloading the wafer 10 from the effector 52 onto the holding face 331.

To keep the effectors 52 stiffness to a maximum and the effector's 52 parking space to a minimum, the tangential distal portion 521 is preferably kept to a minimum. For that purpose, the radial spacing of the pin lifters on the chuck 33 is at a distance such that the circumferential spacing provides for a sufficient gap such that the tangential distal portion 521 may be inserted with a sufficient width. In a preferred embodiment and for a 300 mm diameter wafer 10, the radius of 3 or 4 concentrically and substantially equally arrayed pin lifters 34 is about 1.75 inches.

Actuation and positioning of the pinlifters 34 may be accomplished in any well known fashion or by a compact pinlifter assembly described in the concurrently filed U.S. patent application titled “Compact Pinlifter Assembly” by Daniel Tran, which is hereby incorporated by reference.

To optimize the clamping action initiated by the vacuum in the interface between carrying face 522 and wafer 52 bottom, the carrying face may extend onto the radial arm portion 528. Vacuum grooves 523 are embedded in the carrying face 521 for an even vacuum distribution from the access holes 524 across the carrying face 521. Extending the area of the carrying face 521 proportionally increases the contact pressure and friction clamping in the interface for a given vacuum.

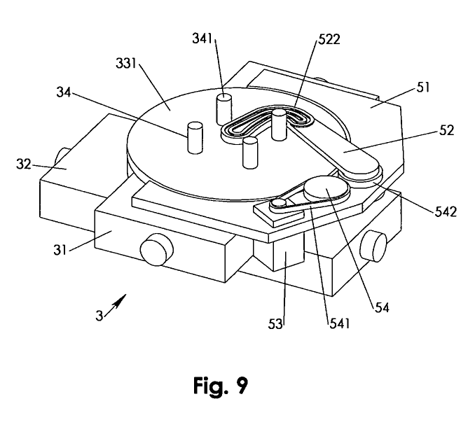

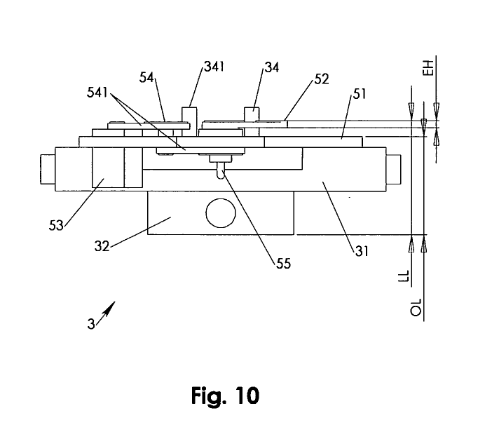

As is additionally shown in FIGS. 9, 10, the robotic single axis system 5 is configured to fit into the tight spatial envelop defined by the spatial constraints described under FIGS. 4 and 6. At one hand all involved elements are fitted within the lateral boundaries of the assembly plate 51. The controller motor 53 and reduction gear 54 are fitted adjacent and within the height of the X-stage 31 and preferably within the loading level LL. The reduction gear 54 utilizes preferably timing belts 541 for a smooth and vibration free reduction of the motor's 53 rotational speed. For a 300 mm diameter wafer 10, a robotic single axis system 5 may fit within a concentric envelop CE to the chuck 33 having a maximum diameter of 21 inches while the effector 52 is in parking position.

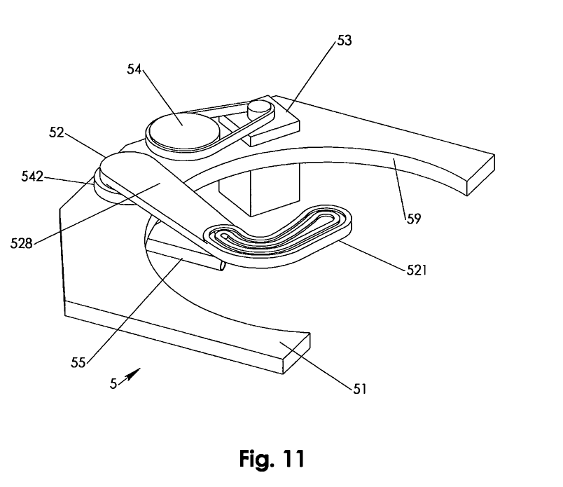

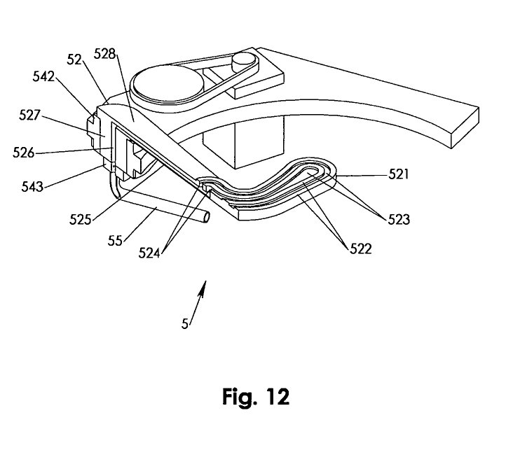

In FIGS. 11 and 12, the robotic single axis system 5 is shown independently as it may be utilized for upgrading a commercially available combined X-Y precision stage. The assembly plate 51 has a central cutout arc 59 for a substantial concentric fit around the chuck 53. The assembly plate 51 has overall an approximate C-shape to fit around the circular chuck 33 and for being attached on top of the combined X-Y stage. A rotation sensor 542 may be employed for recognizing the orientation of the effector 52. The rotation sensor 542 is preferably actuated by the effector's 52 rotatable mounting shaft 527 as depicted in the Figures. A vacuum line is integrated in the effector 52, which includes a horizontal portion 525 propagating within the radial arm between the access holes 524 and a concentric portion 526. The concentric portion 526 propagates along the mounting shaft 527 where it terminates at a non rotating hub 543. In that fashion, a vacuum is communicated from the vacuum supply 55 to the carrying face 522.

The carrying face 522 is slightly raised above the top of the remaining effector 52, such that an eventual deflection of the effector 52 due to the wafer's 10 weight does not compromise the snuggle contact between the wafer 10 bottom the carrying face 522. The effector 52 may be fabricated from highly stiff material such as carbon enforced compound material. The compact configuration of the robotic single axis system 5 provides for a minimum real estate consumption.

Overall the wafer handling system of the present invention provides for a highly precise positioning with a minimum of controlled axis movement. Due to the low number of axis by which the wafer is manipulated, the wafer's 10 transfer may be accomplished in a reliable, quick and efficient manner. Well known computerized controlling means may be employed for controlling the affiliated components.

The present invention includes embodiments, in which the prealigner 8 is a non commercial device specifically configured in conjunction with the elevator 7 and its above taught design particularities as may be well appreciated by anyone skilled in the art.

Accordingly, the invention described in the specification above is set forth by the following claims and their legal equivalent:

1. A wafer testing device comprising:
a. An at least five motion axis computer numeric controlled wafer handling system having:
i. at least one linear precision axis;
ii. one handling rotation axis;
iii. one vertical gross positioning linear axis;
iv. one vertical dual position axis;
Wherein said linear precision movement axis are provided by a linear precision stage combined with a chuck for receiving and positioning said wafer for said optical wafer testing, said linear precision stage having a travel of about the diameter of said wafer and having a positioning accuracy required by a measurement process employed by the wafer testing device;
wherein said rotation axis is provided by a robotic single axis system combined with said linear precision stage in a fixed position relative to a center axis of said chuck, said robotic arm system including an effector having a shaft substantially concentric with said rotation axis and having a distal carrying face, said shaft being immediately adjacent said chuck and rotating said effector between a chuck loading orientation and an elevator alignment orientation, wherein during said chuck loading orientation said carrying face being substantially concentric with said center axis;
wherein said gross positioning axis is provided by an elevator configured for vertically moving a substantially vertically arranged cassette and prealigner such that while said effector is in said elevator alignment orientation said effector may be alternating moved by said linear precision stage in between a number of wafer stacking levels of said cassette to the point where the carrying face is interfering with a wafer stacking axis and into said prealigner with said carrying face interfering with a prealigner operating axis;
wherein said dual positioning axis is provided by pinlifters having a top position in which top faces of said pinlifters are above said carrying face and a bottom position in which said top faces are below a wafer holding face of said chuck such that said wafer may be moved between said wafer holding face and said top position and such that said wafer may be loaded and unloaded from said carrying face while said effector is in said chuck loading position; and
wherein said carrying face is placed on a tangential distal portion of said effector such that said carrying face is rotated into and out of said chuck loading orientation in which said carrying face interferes with a chuck center axis without colliding of the effector with said pin lifters being in said top position.

2. The wafer testing device of claim 1, further comprising:
a. a configuration for testing a wafer with a diameter of about 300 mm; and
b. a head clearance of about 1.25 inches plus a wafer height of about 0.75 mm.

3. The wafer testing device of claim 1, further comprising:
a. a second linear precision stage substantially perpendicular to said linear precision stage; and
b. a virtual loading axis having a loading travel that is substantially the square root of the sums of each of the stage's travel square.

4. A wafer handling system comprising:
a. at least one horizontal linear precision axis;
b. one handling rotation axis;
c. one vertical gross positioning linear axis;
d. one vertical dual position axis;
Wherein said linear precision movement axis are provided by a linear precision stage combined with a chuck for receiving and positioning said wafer for said optical wafer testing, said linear precision stage having a travel of about the diameter of said wafer and having a positioning accuracy required by a measurement process employed by the wafer testing device;
wherein said rotation axis is provided by a robotic single axis system combined with said linear precision stage in a fixed position relative to a center axis of said chuck, said robotic arm system including an effector having a shaft substantially concentric with said rotation axis and having a distal carrying face, said shaft being immediately adjacent said chuck and rotating said effector between a chuck loading orientation and an elevator alignment orientation, wherein during said chuck loading orientation said carrying face being substantially concentric with said center axis;
wherein said gross positioning axis is provided by an elevator configured for vertically moving a substantially vertically arranged cassette and prealigner such that while said effector is in said elevator alignment orientation said effector may be alternating moved by said linear precision stage in between a number of wafer stacking levels of said cassette to the point where the carrying face is interfering with a wafer stacking axis and into said prealigner with said carrying face interfering with a prealigner operating axis;
wherein said dual positioning axis is provided by pinlifters having a top position in which top faces of said pinlifters are above said carrying face and a bottom position in which said top faces are below a wafer holding face of said chuck such that said wafer may be moved between said wafer holding face and said top position and such that said wafer may be loaded and unloaded from said carrying face while said effector is in said chuck loading position; and
wherein said carrying face is placed on a tangential distal portion of said effector such that said carrying face is rotated into and out of said chuck loading orientation in which said carrying face interferes with a chuck center axis without colliding of the effector with said pin lifters being in said top position.

5. The wafer handling system of claim 4, further comprising:
a. a second linear precision stage substantially perpendicular to said linear precision stage; and
b. a virtual loading axis having a loading travel that is substantially the square root of the sums of each of the stage's travel square.

6. A robotic single axis system comprising:
a. an assembly plate having a central cutout arc for attaching said robotic single axis system to a stage system substantially concentric to a chuck of said stage system;
b. controlled motor attached to said assembly plate and embedded within lateral boundaries of said assembly plate;
c. an effector having:
i. a rotatable mounted shaft rotatable attached to said assembly plate and embedded within said lateral boundaries of said assembly plate;
ii. a radial arm portion;
iii. a tangential arm portion at a distal end of said radial arm portion;
iv. a vacuum actuated carrying face at said tangential arm, said carrying face being configured for fixedly holding a wafer while said wafer is snuggly contacting said carrying face and while a vacuum is applied;
v. an internal vacuum line between said carrying face and a non rotating hub adjacent said shaft for applying said vacuum to said carrying face via said hub;
wherein said radial arm portion and said tangential arm portion are such that said effector fits within said lateral boundaries of said assembly plate while said effector is in a parking position;
d. a reduction gear coupling said motor and said shaft while reducing a rotational speed of said motor into an angular speed of said effector, said reduction gear being attached to said assembly plate and embedded within said lateral boundaries of said assembly plate;
e. a rotation sensor for recognizing at least one of an angular orientation and a rotational speed of at least one of said effector and said motor, said rotation sensor being attached to said assembly plate and embedded within lateral boundaries of said assembly plate; and
f. a vacuum actuation means for actuating a vacuum at said hub, said vacuum actuation means being embedded within lateral boundaries of said assembly plate.

7. The robotic single axis system of claim 6, wherein said lateral boundaries fit within a concentric envelop of a chuck for carrying a wafer having a diameter of about 300 mm diameter, said concentric envelop having a diameter of maximum about 21 inches with said effector being in parking position.

8. A wafer effector comprising:
c. a rotatable mounted shaft;
d. a radial arm portion;
e. a tangential arm portion at a distal end of said radial arm portion;
f. a vacuum actuated carrying face at said tangential arm portion, said carrying face being configured for fixedly holding a wafer while said wafer is snuggly contacting said carrying face and while a vacuum is applied; and
g. a vacuum line between said carrying face and a non rotating hub adjacent said shaft for applying said vacuum to said carrying face via said hub.
